(19) United States
(12) Patent Application Publication
(10) Pub. No.: US 2006/0144316 A1
(43) Pub. Date: Jul. 6, 2006

(54) Bookmark sleeve containing a note taking medium

(76) Inventor: Lucy L. Johnson, Yardley, PA (US)

Correspondence Address: Kenneth Watov;WATOV & KIPNES, P.C., P.O. Box 247, Princeton Junction, NJ, 08550, US

(21) Appl. No.: 11/030,514

(22) Filed: Jan. 6, 2005

(51) Int. Cl. B42D 9/00

(52) U.S. Cl. 116/234

(57) ABSTRACT

A bookmark for holding a place in a book by a reader includes a sleeve member defining a cavity in communication with an opening; and a note taking medium being removably stored in the cavity, and accessible by the reader through the opening of the sleeve member, wherein the note taking medium supports a surface on which indicia can be applied thereon by the reader.

### FIELD OF THE INVENTION

The present invention relates generally to place markers for books, and more particularly to a bookmarker adapted for enabling a reader during the course of the reading to write comments and annotations for subsequent review, and for holding a place in the book when the reading stops.

### BACKGROUND OF THE INVENTION

The use of a place holder for making a place in a paged item of written material, such as a book, is known in the art. Such place holders include bookmarks, index tabs, ribbons, and the like.

The most common example of such a place holder is a common bookmark, which generally consists of a strip of light cardboard, typically about 3 cm in width and 10 cm long. It is common for such bookmarks to have a wide range of different types of printed matter on them. Such printed matter may simply include decorative designs, or an inspirational saying. Such bookmarks are used by simply being placed between the pages of the book, typically near the spine of the book, to mark a particular page in the book to which a reader wishes to return, or which contains some item of information to which the reader expects to want to refer back.

Bookmarks probably came into use as quickly as some book reader with a scrap of paper, discovered, undoubtedly ages ago, that he could mark his place with it. It would appear that the use of a ribbon secured to the binding at the spine of a book was also a very early innovation, which prevented the ribbon bookmark from being disassociated from the book and lost.

More recently, relatively stiff materials have been used for bookmarks, such as plastic. Accordingly, some bookmarks have a tongue cut into them, allowing the tongue to be placed on one side of a page, and the rest of the bookmark on the other side of the same page, in much the manner of a paper clip, allowing the bookmark to remain secured to the page even when the book is opened and the page moved. This also allows placement of the bookmark in a secure fashion at a wide variety of positions remote from the spine or binding of the book.

Accordingly, there is a need for a bookmark for permitting the reader to hold a place in a book, when the reader stops reading, and to provide a writing surface on which the reader can write notations or commentary during the course of the reading.

### SUMMARY OF THE INVENTION

The present invention relates generally to a bookmark for enabling a reader to hold a place in the book, when the reader stops reading. The bookmark of the present invention generally includes a sleeve member defining an interior cavity in communication with an opening, and a note taking medium providing a surface on which indicia can be printed or written thereon by the reader in the form of notations or commentary. After use, the note taking medium is stored in the cavity of the sleeve, and the sleeve then used to mark the page where the reader last read. The reader can thereafter return to the held place or page in the book, and during the course of the reading, again remove the note taking medium from the sleeve to record notes and commentary that the reader may wish to review at a subsequent time. The sleeve member combined with the note taking medium contained in its cavity is configured to be thin enough to not cause damage to the binding or pages of a book in which the combination is inserted.

In one aspect of the present invention, there is provided a bookmark for holding a place in the book by the reader, comprising:

a sleeve member defining a cavity in communication with an opening; and

a note taking medium being removably stored in the cavity, and accessible by the reader through the opening of the sleeve member, wherein the note taking medium supports a surface on which indicia can be applied thereon by the reader.

### BRIEF DESCRIPTION OF THE DRAWINGS

Various embodiments of the invention are described in detail below with reference to the drawings, in which like items are identified by the same reference designations, wherein:

FIG. 1 is a perspective view of a bookmark in use marking the location of a page in a book in accordance with the present invention;

FIG. 2 is a front perspective view of the bookmark for one embodiment of the present invention;

FIG. 3 is a front elevational view of the bookmark with a note taking medium pulled partially therefrom in accordance with the present invention;

FIG. 4 is a rear elevational view of the bookmark of FIG. 3 with an optional page clip mechanism in accordance with the present invention;

FIG. 5 is a perspective view of the note taking medium removed from the bookmark and partially unfolded in accordance with the present invention; and

FIG. 6 is a perspective view of a note taking medium for a second embodiment of the present invention.

### DETAILED DESCRIPTION OF THE INVENTION

The present invention is directed to a bookmark composed of a sleeve member and a note taking medium housed in the sleeve member. The bookmark of the present invention includes a sleeve member, and at least one removable note taking medium in the form of a foldable sheet located in the sleeve member for enabling the reader to write or make notations thereon. The bookmark of the present invention allows the reader to make annotations and comments during the course of reading a book for subsequent viewing. The bookmark of the present invention is relatively simple, and easy to use for its intended purpose. The bookmark of the present invention is cost efficient to manufacture, attractive in appearance, and very effective in offering an acceptable note taking medium for recording notes and annotations.

The term “note taking medium” encompasses any substantially blank piece of material having a surface on which indicia can be permanently or removably applied, printed, or written thereon by the reader.

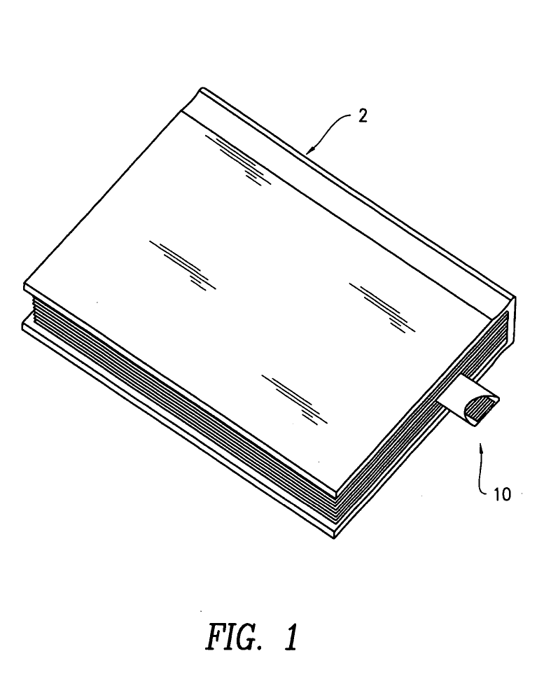

With reference to FIG. 1, there is provided a bookmark designated generally by the reference numeral 10. The bookmark 10 is placed between pages in a book 2 to hold a location or page that the reader will return to read. The bookmark 10 can be constructed to any size and shape to fit any sized book 2.

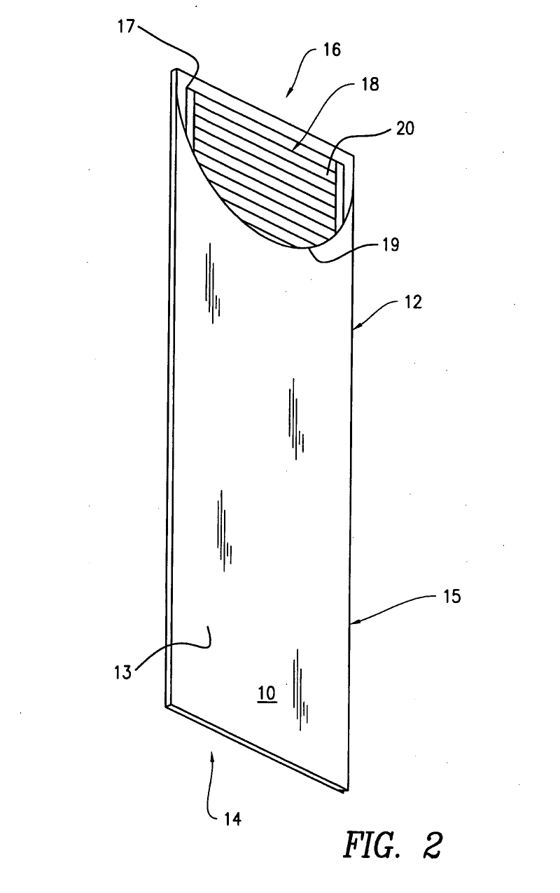

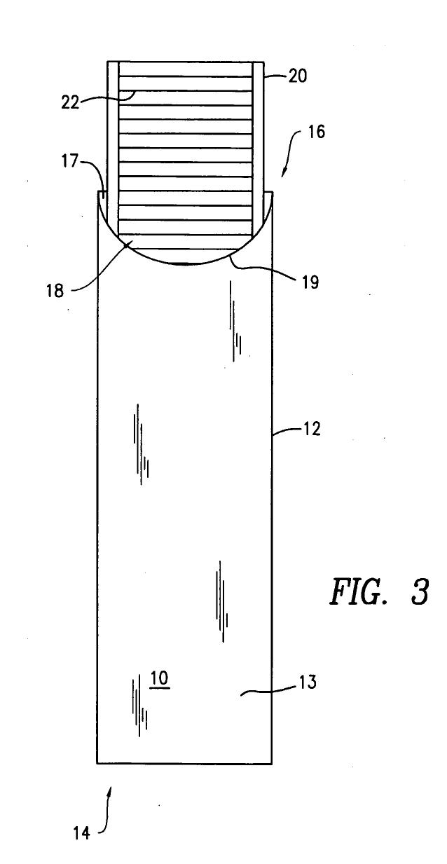

Referring to FIGS. 2 and 3, the bookmark 10 generally comprises a sleeve member 12 having a lower end 14 and an open upper end 16, and a cavity 17 in communication with an opening 18 at the upper end 16 of the sleeve member 12. The bookmark further comprises a note taking medium 20 stored in the cavity 17 and retrievable through the opening 18, as best shown in FIG. 3. The note taking medium 20 can be removably stored in the sleeve member 12 by sliding the note taking medium 20 into or out of the cavity 17 via the opening 18. In the present embodiment, the opening 18 can be configured with a U-shaped edge 19 so that a portion of the note taking medium 20 is exposed to facilitate easy grip and removal therefrom by the reader's fingers. Optionally, the opening 18 can further include a closure in the form of a flap (not shown) to secure the note taking medium 20 within the cavity 17 of the sleeve member 12.

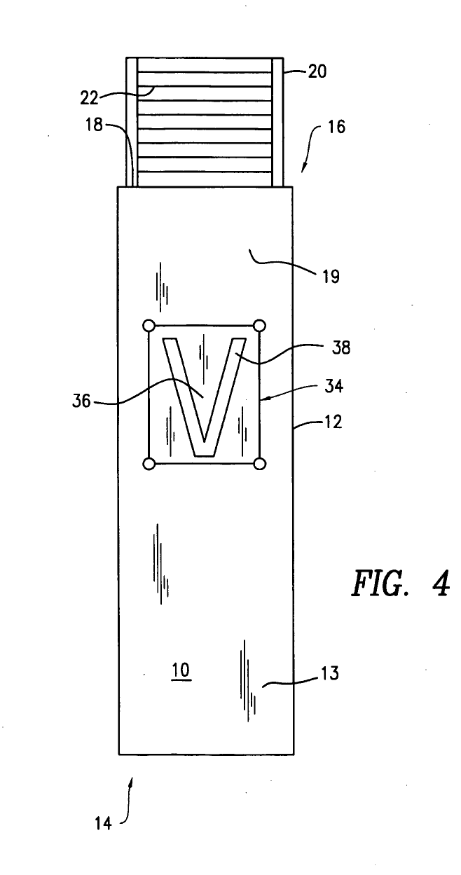

The sleeve member 12 is generally rectangular shaped with a substantially flat front and back faces 13 and 15, respectively (see FIGS. 3 and 4). The front and back faces 13 and 15, respectively, can be adapted to accept indicia for conveying designs, logos, characters, or the like. In using the bookmark 10, it is placed in the book 2 between facing pages for indicating locations in those facing pages, where the reader had previously left off. The note taking medium 20, as shown, includes a series of horizontal lines 22 on which the reader can conveniently write notes, commentaries, annotations and the like therebetween. However, the note taking medium 20 can also be blank, or contain other preprinted note taking aids.

Referring to FIG. 4, in a preferred embodiment of the invention, the bookmark 10 further includes a clip mechanism 34 affixed to the back face 15 of the sleeve member 12 via a suitable fastening means such as an adhesive, for example. The clip mechanism 34 comprises a clip tab 36 biased in a spring-like manner against the back face 15 of the sleeve member 12. A page receiving gap 38 is defined between the clip tab 36 and the back face 15 of the sleeve member 12. The page receiving gap 38 is adapted to receive a portion of a page to which a reader may removably insert therein. Once in place, the clip tab 36 securely retains the page portion in the page receiving gap 38. In this manner, the bookmark 10 remains secured in place within the book 2 and is less likely to fall or slip out from the held place, or become hidden by slipping down between pages of the book 2. It will be understood that the clip mechanism 34 is not limited to the type shown in the drawings, but may include other types as known to one of ordinary skill in the art. The clip mechanism 34 can be composed of a resilient and durable material such as plastic or metal that can be securely attached to the sleeve member 12 via suitable fastening means. However, the bookmark 10 can be provided for use without the clip mechanism 10.

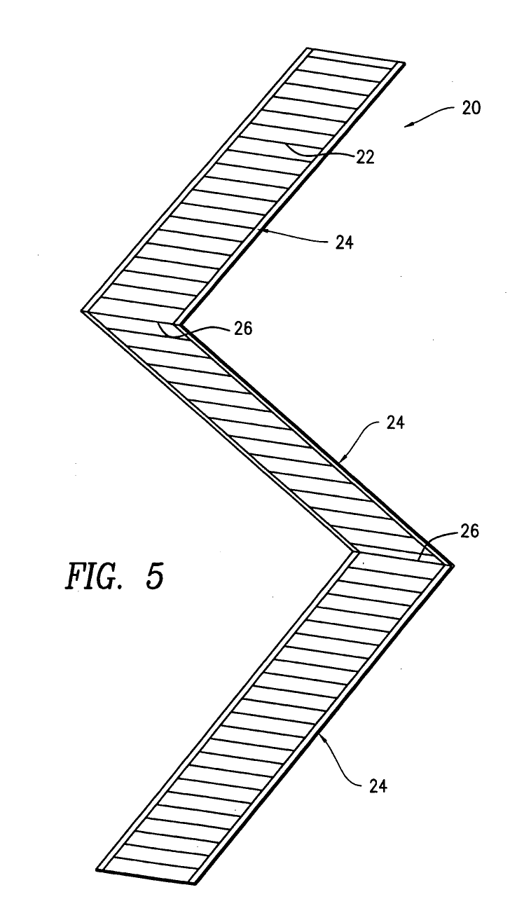

Referring to FIG. 5, the note taking medium 20 is shown removed from the sleeve member 12. In one embodiment of the invention, the note taking medium 20 is composed of a thin strip of foldable material optionally having a series of lines 22 preprinted for writing. The note taking medium 20 further is composed of multiple sections 24 foldable onto one another at fold lines 26, respectively. This configuration enables the note taking medium 20 to be compactly stored in the sleeve member 12, while enhancing the capacity of the note taking medium 20 to accommodate printed or written indicia in the form of notations by the reader. In the folded state, the note taking medium 20 is suitably dimensioned to be stored in the cavity 17 of the sleeve member 12.

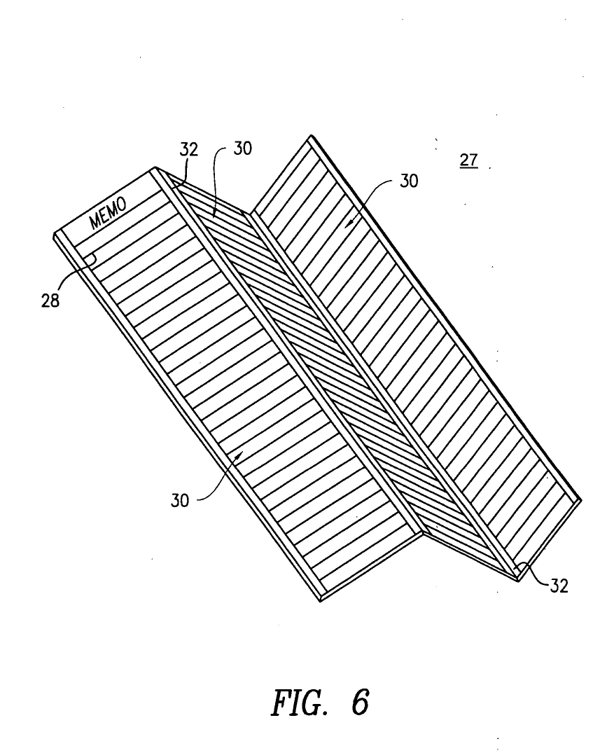

Referring to FIG. 6, a note taking medium 26 is shown for another embodiment of the present invention. Similar to the previous embodiment of the present invention, the note taking medium 26 includes a series of lines 28 for receiving indicia, and is partitioned into multiple sections, such as three sections 30 folded at fold lines 32 extending longitudinally between adjacent sections 30, for example. In the folded state, the note taking medium 26 is suitably dimensioned to be stored in the cavity 17 of the sleeve member 10.

The bookmark of the present invention including the sleeve member and the note taking medium can compose any suitable flat, durable and foldable material having a surface on which the reader can print or write notations and the like thereon. Such materials can be selected from paper, leather, canvas, vinyl, cardboard, plastic polymer, foil and the like. In a preferred embodiment, the bookmark is composed of a material exhibiting sufficiently high tensile strength for enhanced tear resistance. Such material may be selected for its tensile strength.

Accordingly, it is preferable that the material for the note taking medium and optionally the sleeve member be selected for its tensile strength. A preferred material that can be made into envelopes much in the same fashion as paper is a spun bonded olefin material sold by Dupont Inc. under the trademark TYVEK. This material has a strip tensile strength of approximately 7.9 pounds per square inch.

Although various embodiments of the invention have been shown and described, they are not meant to be limiting. Those of skill in the art may recognize various modifications to these embodiments, which modifications are meant to be covered by the spirit and scope of the appended claims.

1. A bookmark for holding a place in the book by a reader, said bookmark comprising:
a sleeve member defining a cavity in communication with an opening; and
a note taking medium configured to be removably stored in the cavity of said sleeve member, and accessible by the reader through the opening of the sleeve member, wherein the note taking medium supports a resilient writable surface on which indicia can be applied thereon by the reader.

2. The bookmark of claim 1, wherein the sleeve member further comprises a closed first end and an open second end defining the open end of the cavity in which the note taking medium is stored.

3. The bookmark of claim 1, further comprising a clip attached to the sleeve member.

4. The bookmark of claim 1, wherein the note taking medium is composed of a material selected from the group consisting of paper, polymer, foil and combinations thereof.

5. The bookmark of claim 4, wherein the note taking medium is provided by a spun bonded olefin material.

6. The bookmark of claim 1, wherein the note taking medium exhibits a tensile strength of at least 7 pounds per square inch.

7. (canceled)

8. The bookmark of claim 1, wherein the note taking medium is folded into multiple sections for insertion into the cavity of the sleeve member.

9. The bookmark of claim 8, wherein the multiple sections of the note taking medium are folded along associated transverse fold lines.

10. The bookmark of claim 8, wherein the multiple sections of the note taking medium are folded along associated longitudinal fold lines.

11. A method for providing a bookmark comprises the steps of:
forming a sleeve member with a closed end and an open end, the open end providing access to a cavity between opposing front and back portions of said sleeve;
forming a note taking medium configured to be removably stored in the cavity of said sleeve member, and accessible by the reader through the opening of the sleeve member, wherein the note taking medium supports a resilient writable surface on which indicia can be applied thereon by the reader; and
folding said note taking medium in a manner permitting its removable storage with the cavity of said sleeve.

12. The bookmark of claim 1, wherein the note taking medium is tear resistant.
